(19) United States
(12) Patent Application Publication
(10) Pub. No.: US 2005/0118297 A1
(43) Pub. Date: Jun. 2, 2005

(54) Molded concrete foundation element and method for its manufacture

(76) Inventor: Dov Steinberg, Kazir (IL)

Correspondence Address: NATH & ASSOCIATES, 1030 15th STREET, NW, 6TH FLOOR, WASHINGTON, DC, 20005, US

(21) Appl. No.: 10/507,852

(22) PCT Filed: Feb. 12, 2003
(86) PCT No.: PCT/IL03/00106

(30) Foreign Application Priority Data
Mar. 25, 2002 (IL) 148877

(51) Int. Cl. B28B 21/22; E02D 27/00

(52) U.S. Cl. 425/435; 264/308; 264/311; 52/292

(57) ABSTRACT

A foundation element (20), symmetrical about a longitudinal axis thereof, and formed with a crust made of at least normal-strength concrete. The crust envelops a core made of aggregate material dispersed such that the size of the aggregate material increases from fine to large about a radial section of the element.

### FIELD OF THE INVENTION

The present invention is generally in the field of solid concrete elements. More particularly, the invention is concerned with centrifuge-cast foundation elements, their manufacture and an apparatus for manufacturing same.

Such elements are often referred to in the art as ‘armor units’ or ‘armor elements’.

The term “foundation element” used hereinafter in the specification and claims is used in its broadest aspect and denotes a variety of foundation/construction elements, e.g. as a bed for marine construction, wave breakers, dams, supportive walls, soil foundation and consolidation, etc.

### BACKGROUND OF THE INVENTION

Use of foundation elements for various construction purposes is well known. At times, large rocks are used for such purposes. However, a disadvantage concerned with using rocks is the availability of such large rocks and the expenses involved with quarrying and transportation of the rocks to the work site.

Rather than using rocks, there is an ever-growing use of molded foundation elements which are relatively cheap and which may also be molded at or adjacent the work site. Even more so, in molding such elements, one may also control the mechanical properties of the elements, e.g. the compressive strength, weight, wear resistance, etc., by controlling different parameters such as type of concrete used, additives used (binders and aggregates), amount of liquid added, entrapped air, etc. Still, one may control the shape and the size of the elements to thereby impart them with various properties so as to meet requirements of a particular construction site.

Presently, foundation elements of the concerned type are molded in a harmonized manner, i.e. the distribution of aggregate material (typically gravel) through a section of the element is essentially equal.

U.S. Pat. Nos. 4,976,291 and 5,035,850 disclose a concrete-type composite pipe produced by rotating a drum mold while casting concrete there into to form a concrete layer of a uniform thickness using a centrifugal force exerted on the cast concrete, casting a corrosion protective layer on an inner surface of the formed concrete layer, scattering aggregates on the inner surface and accelerating the rotation to cause the aggregates or the like to form an intermediate layer between the concrete layer and the corrosion protective layer.

It is an object of the present invention to provide a concrete-molded foundation element formed with a durable crust, enveloping a core consisted of aggregated material indexed in an inverted segregation dispersion. It is a further object of the present invention to provide a method for production of such foundation elements and an apparatus for carrying out such a method.

### SUMMARY OF THE INVENTION

It is an object of the present invention to provide a construction element formed with a durable concrete crust having an external surface with a relatively high compressive strength, said crust enveloping a core made of aggregate material indexed in inverted segregation dispersion.

According to the present invention there is provided a foundation element, symmetrical about a longitudinal axis thereof, said element formed with a crust made of at least normal-strength concrete, said crust enveloping a core made of aggregate material dispersed such that the size of the aggregate material increases from fine to large about a radial section of the element and where space between larger aggregate material is occupied by smaller sized aggregate material. The construction element is molded in a centrifugal process.

The arrangement is such that large aggregate material is disposed adjacent an outer surface of the crust and small aggregate material is disposed at the center of the element.

In accordance with a particular embodiment of the invention, the core material comprises waste material. Such waste material may consist of fly ash, polymeric waste material, radioactive contaminated material, etc. This is an environmentally friendly method for getting rid of such waste material.

In accordance with an other particular embodiment, the construction element is fitted with at least one hoisting-eye. By a preferred embodiment, the hoisting-eye is received within an indention or depression such that it does not project beyond a top surface of the foundation element.

The construction element in accordance with the present invention may have different cross-sections, e.g. cylindrical, triangular, square, hexagonal, octagonal, etc. According to a particular design, where the cross-section of the construction element is polygonal, the number of faces is at least five, so as to avoid significantly differing distance from the center of the core.

In accordance with a further aspect of the present invention, there is provided a method for manufacturing a foundation element symmetrical about a longitudinal axis thereof, said method comprising:
(i) obtaining a centrifugal mold formed with a bottom base and side walls extending upwards therefrom;
(ii) introducing at least normal-strength concrete into the mold;
(iii) rotating the mold so as to generate centrifugal force acting on the cement thus forming a peripheral crust;
(iv) decreasing rotation speed of the mold and introducing an additional amount of at least normal-strength concrete into the mold to form a bottom base crust, continuous with the peripheral crust;
(v) introducing into the mold aggregate core material comprising graded material indexed between large size and small sized substance material;
(vi) rotating the mold at high speed whereby the said crust envelopes the core such that the size of the aggregate material increases from fine to large about a radial section of the element;
(vii) stopping the mold and adding an additional amount of at least normal-strength concrete into the mold to form a top base crust, continuous with the peripheral crust; and

(viii) drying the element.

According to a modification of the invention, steps (ii) to (v) may be replaced by introducing a mixture comprising cement and a mixture of aggregate material comprising graded material indexed between large size and small sized substance material.

In accordance with still a modification, any time after step (v) liquids may be drained or suctioned from the mold which was drawn liquid may then be replaced by substitute material such as cement.

The invention is further concerned with an apparatus for molding a foundation element, comprising a mold mountable on a rotatable plate member; said mold comprising a base, peripheral side walls extending therefrom and a top cover attachable to the side walls; said top cover comprising an inlet opening.

### BRIEF DESCRIPTION OF THE DRAWINGS

For better understanding the invention and its different aspects, and to see how it may be carried out in practice, reference will now be made to the accompanying drawings, by way of example only, in which:

FIG. 1A is a longitudinal section through a foundation element in accordance with the present invention;

FIG. 1B is a horizontal section along lines II-II in FIG. 1A;

FIG. 2A is a schematic representation of an apparatus for manufacturing a foundation element in accordance with the present invention;

FIG. 2B is a longitudinal section of a mold used in the apparatus of FIG. 2A;

FIGS. 3A to 3E are schematic illustrations of the steps for manufacturing a foundation element in accordance with the present invention; and

FIG. 4 is a schematic representation illustrating manufacturing of foundation elements at a marine site.

### DETAILED DESCRIPTION OF THE INVENTION

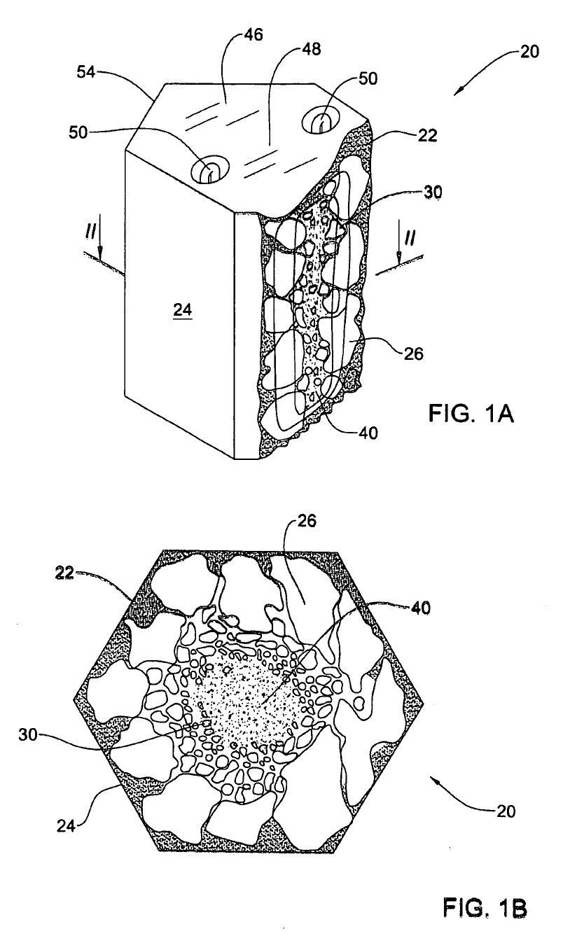

Attention is first directed to FIGS. 1A and 1B of the drawings illustrating a foundation element in accordance with an embodiment of the present invention, generally designated 20. The element 20 has a hexagonal cross-sectional shape and is essentially symmetrical about its longitudinal axis. However, it is appreciated that other symmetrical shapes are possible too, though in particular circular or such shapes in which the faces are disposed at significantly blunt angles, e.g., an octagonal cross-section, etc. The size of the element 20 may vary, depending on the intended use.

Element 20 has a crust 22 typically made of normal to high-strength concrete, having a compressive strength of at least 20 MPa. The crust 22 has an outer surface 24 obtaining its shape and pattern from the mold in which it is molded, as will be discussed hereinafter. The cement slurry/paste used for obtaining the concrete crust is made of a mixture of Portland, or other type of cement, with water and at times some additives, as known per se, imparting the concrete with desired parameters e.g. corrosive-resistance, etc. The ratio of cement to water determines the strength of the concrete, namely its compressive strength, and according to the intended use of the foundation elements one decides which concrete to use.

Dispersed inwardly of the crust layer 22 there is large aggregate material in the form of large stones 26 (crushed rock and large gravel), which during the centrifugal molding process are forcefully urged towards the surface 24 of the crust layer 22. It is apparent that the space between larger aggregate material is occupied by smaller sized aggregate material.

Inward from the large aggregate material 26 and in the voids and gaps therebetween, there is dispersed medium size aggregate material 30, e.g. small stones, gravel, etc., with a low amount of cement therebetween. Further inward there is fine aggregate material 40, e.g. sand, filling the gaps between the small aggregate material and comprising a minimal percent of cement.

The innermost layer of the element 20 comprises, in the molding process, the excessive water. After drying what remains is fine aggregate material 40 e.g. various types of sand, and air voids

As can be further seen in FIG. 1A, the foundation element 20 has a top base 46 with a downcast central portion at 48 which appears during the drying process of the element 20. Further noted, the element 20 is fitted with two hoisting hooks 50, inserted into the foundation element during the molding process, which do not extend beyond the upper edge 54 of the element. This ensures that in stacking like elements on top of one another the hosting hooks 50 do not deform.

Reverting now to the aggregate core material, it is apparent that it consists of material indexed in an inverted segregation dispersion such that large aggregate material 26 is disposed adjacent the outer surface 24 of the crust 22 with fine aggregate material 40 disposed at the center of the element 20. This arrangement is obtained during the molding process of the core of the element 20, which is carried out under centrifugal forces, whereby the heavier material is radially urged toward the outer surface 24 of the crust 22.

The core material may comprise waste material in various forms, e.g. granulated or powdered material, fibers, compressed material, crushed material, etc. The waste material may be any environmentally hazardous material of which it is desired to dispose of, e.g. polymeric material, fly ash, radioactive-contaminated material, etc. It is thus advantageous that when a foundation element comprises waste components, e.g. radioactive contaminated material, the crust 22 be made of high-strength concrete, e.g. having a compressive strength of at least 50 MPa, so as to increase safety.

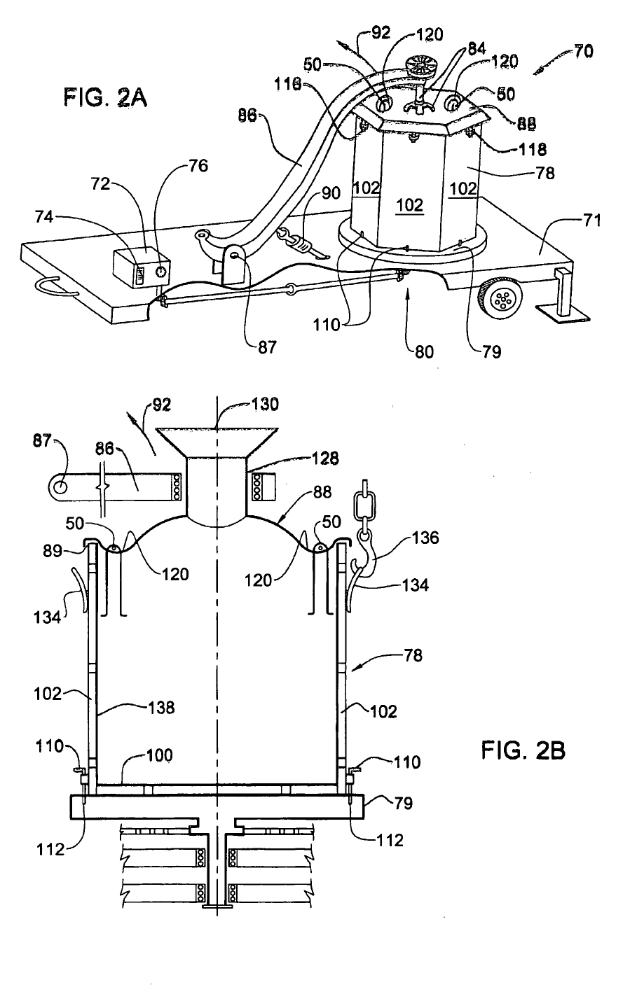

Further attention is now directed to FIGS. 2A and 2B illustrating a form of an apparatus useful in manufacturing a foundation element in accordance with the present invention and as disclosed hereinabove. The apparatus generally designated 70 is in the form of a towable platform 71 and is self-provided with a power unit 72, typically a motor fitted with a control panel 74 and a revolution counter 76. A mold 78 is fixable to a rotatable plate 79 mounted on the platform 71. The rotatable plate 79 is fitted with a transmission 80 for imparting it with rotary motion about its longitudinal axis. The mold 78 is fitted with a cover 88 supported at neck 84 by a support arm 86 pivotably articulated at a pin 87 to the platform 71. The arm 86 serves also for closing and opening and opening the cover 88, possibly by the aid of a pneumatic or hydraulic piston 90, for assisting in pivotally displacing arm 86 in the direction of arrow 92.

As can further be noted in FIG. 2B, mold 78 comprises a base plate 100 from which upwardly extend side walls 102 which give rise to form a mold having a hexagonal cross-section. Each of the walls 102 is pivotally secured to the base plate 100. Alternatively, the sides walls 102 are separated from the base plate 100.

The side walls 102 are fitted at their bottom ends with engagement pins 110 for securing into corresponding openings 112 formed in the rotatable plate 79 (FIG. 2B) to thereby transfer rotary motion from the rotating plate 79 to the mold 78.

Cover 88 of the mold 78 comprises a plurality of downwardly extending projections 116 (FIG. 2A) for engagement with corresponding brackets 118 at the sides walls 102, which cooperate together to secure the mold in particular during rotation thereof when significant centrifugal forces act on the walls 102.

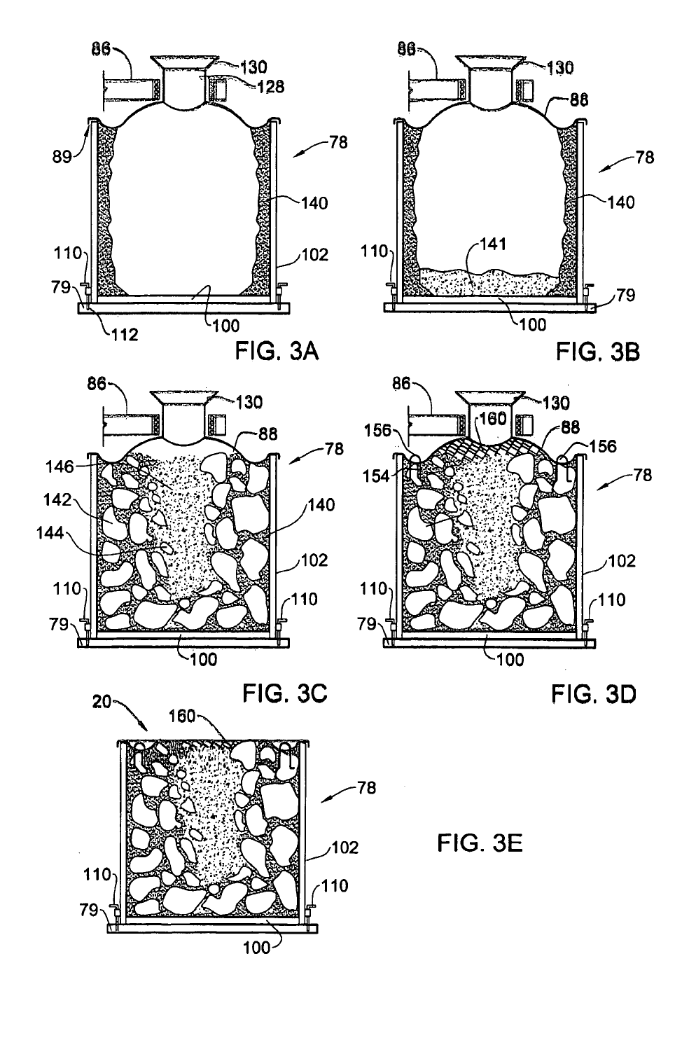

It is further noted that the top cover 88 is formed with two depressions 120, each of which is formed with an opening for receiving a hoisting eye-hook 50 to be integrally molded with the foundation element 20 (see FIGS. 2B, 3D and 3E).

The device of FIG. 2B differs from the device shown in FIG. 2A in that the cover 88 is integrally formed with a supporting neck portion 128 extending from a funnel-like opening 130, through which cement and other ingredient material may be introduced into the mold. The neck portion 128 is embraced by a suitable bearing of the support arm 86, coaxially above a corresponding support at the bottom side of the rotary plate 112. Also noted in FIG. 2B, at least some of the side walls 102 are provided with hoisting hooks 134 for lifting the mold by a suitable hook 136 depending from a crane, etc. (FIG. 2B).

It is to be appreciated by a versed person that the mold 78 may have different cross-sections and different sizes as previously discussed in connection with the foundation element. Furthermore, the inner surfaces 138 of the walls 102 may be textured to thereby impart the external surface of the foundation element 20 with a corresponding decorative texture. Even more so, the walls 102 of the mold 78 may have a non-parallel cross-section, e.g. a rhombus-like cross-section.

In order to understand the method of manufacturing a foundation element in accordance with the present invention, further attention is now directed to FIGS. 3A-3E.

In a first step, a mold 78 is placed on rotatable plate 78 and is rotatably fixed thereto by means of engagement pins 110 projecting into corresponding openings 112 of the rotating plate 79 (see FIG. 2B). Then, the mold cover 88 is placed over the mold 78 and is secured in position by means of support arm 86. In the embodiment of FIG. 2B the side walls are arrested by a peripheral groove 89 receiving the upper edge of the side walls and preventing them from yielding and radially displacing under centrifugal force. However, in the embodiment of FIG. 2A, the side walls are arrested by the projections 116 of cover 88 projecting into the corresponding brackets 118 of the side walls 102.

A cement slurry/paste is poured through funnel 130 into the mold 78, while the mold 78 is rotating at a relatively high speed, thus imparting the slurry with centrifugal forces urging it against the inner walls 102 of the mold 78. After some time, when the cement is partially solid and retains its position as in FIG. 3A, forming a side wall crust 140, the rotational speed of the mold 78 is slowed down. At this point the crust 140 remains stable and maintains its form.

After the rotation of the mold 78 is significantly slowed down, an additional amount of cement slurry is introduced through funnel 130 allowing it to fall to the bottom of the mold 78 and form a bottom crust 141 (FIG. 3B).

Then an aggregated core material is introduced through funnel 130. The aggregate material comprises a mixture of large stones 142, small stones, e.g. gravel 144 and fine aggregate material, e.g. various types of sand 146. Upon insertion of the aggregate mixture, the speed of rotation of mold 78 is increased thereby urging the aggregate material to disperse in a so-called inverted segregation dispersion whereby the large stones 142 are forced to penetrate into the enveloping crust 140 formed in the previous step (see FIG. 3A) and such that the fine aggregate material 146 is disposed at the center of the mold 78, as in FIG. 3C. As an option, the aggregate material may be introduced into the mold 78 at an indexed order, i.e. first the large stones 142 and finally the fine aggregate material 146.

The speed of rotation of the mold 78 and the duration of rotation depend on the consistency of the concrete as well as on the size and specific weight of the aggregate material. If desired, waste material may be introduced into the core material, e.g. waste polymeric material, fly ash, radioactive contaminated material, etc. of which it is desired to dispose of in an environmentally friendly manner. For such a purpose, it is desired that the crust layer 140 be of at least normal and preferably high-strength concrete, depending on the intended use of the foundation element 20 and on the ingredients of the core material. For example, for marine use and where radioactive-contaminate material is introduced as waste material, it would be preferable that the crust be of high-strength type and have a compressive strength of at least 50 NPa. Furthermore, it may be advantageous that in the first step, a corrosive-resistant layer be applied on the inner surface 138 of the mold 78 or together with the slurry forming the crust 140 to impart the foundation element 20 with corrosive resistance.

In accordance with a modification of the invention, liquid may be drained from the mold or suctioned by a suitable pump arrangement (not shown) to allow substituting the removed liquid, typically water, by a heavy substance such as, for example, a cement slurry or other reinforcing or adhering agent.

Turning now to FIG. 3D, a pair of eye-hooks 154 is introduced into the mold through suitable openings formed in the cover 88 such that only a looped portion 156 projects from the opening in the cover 88 and do not exceed over an uppermost edge of the side walls 102. Then, a concrete slurry is introduced through funnel 130 so as to form a top crust 160 of the foundation element 20.

The process then ends by elevating the cover 88 (by means of arm 86) and hoisting away the mold 78 and allowing the molded element to consolidate and heal at a suitable drying site (FIG. 3E). Then, after a predetermined period of time the side walls 102 are removed and the foundation element 20 is ready for use as disclosed hereinabove.

As an alternative, rather then first molding the crust 22 and then adding the aggregate material, one may combine these steps by introducing into the mold 78 a mixture comprising the cement and the mixture of aggregate material comprising graded material indexed between large sized and small sized material, whereby the cement and the aggregate material will disperse during rotation of the mold 78 at high speed, under the influence of centrifugal force.

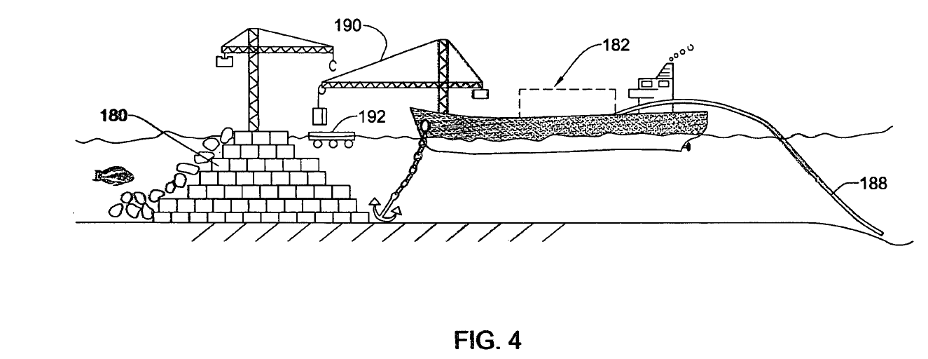

Turning now to FIG. 4 there is illustrated schematically a marine site where a plurality of foundation elements 180 are to be laid. A foundation-element manufacturing site 182 is in the form of a floating barge or ship, where water supply is from the sea (with necessary water-treating means provided) as well as fine aggregate material (e.g. sand) which is sucked from the sea bed by means of a pipe 188. The large aggregate material 26, e.g. stones and gravel are stored aboard or may be transferred thereto. The foundation elements 180 manufactured on board the floating barge are then transferred by cranes 190 or floating barge 192 to the site at which the foundation elements 180 are to be laid.

Obviously, foundation elements of different shape and size are used as desired according to various engineering and other considerations.

1. A foundation element, symmetrical about a longitudinal axis thereof, said element formed with a crust made of at least normal-strength concrete, said crust enveloping a core made of aggregate material dispersed such that the size of the aggregate material increases from fine to large about a radial section of the element.

2. A foundation element according to claim 1, wherein the crust has a compressive strength of at least 20 MPa.

3. A foundation element according to claim 1, wherein the aggregate material is indexed in inverted segregation dispersion, whereby large aggregate material is disposed adjacent an outer surface of the crust and small aggregate material is disposed at the center of the element and where voids between larger aggregate material is occupied by smaller sized aggregate material.

4. A foundation element according to claim 1, wherein an external surface of the core is made of a corrosion resistant material.

5. A foundation element according to claim 1, wherein an external surface of the crust is made of high-strength concrete having a compressive strength of at least 50 MPa.

6. A foundation element according to claim 1, wherein the core comprises waste material.

7. A foundation element according to claim 6, wherein the waste material comprises fly ash.

8. A foundation element according to claim 6, wherein the waste material comprises polymeric material.

9. A foundation element according to claim 6, wherein the waste material comprises radioactive contaminated material.

10. A foundation element according to claim 1, fitted with at least one hoisting-eye.

11. A foundation element according to claim 1, made in a centrifugal molding process.

12. A foundation element according to claim 3, wherein the large aggregate material is coarse material comprising stones and gravel and the fine aggregate material comprises sand.

13. A foundation element according to claim 3, wherein the voids between large aggregate material are filled with small aggregate material arranged in inverted segregation dispersion.

14. A foundation element according to claim 1, wherein the element has a cylindrical cross-section.

15. A foundation element according to claim 1, wherein the element has a polygonal cross-section.

16. A foundation element according to claim 15, wherein the element has a cross-section having at least three faces.

17. A foundation element according to claim 1, wherein the element has a hexagonal cross-section.

18. A foundation element according to claim 15, wherein the element has an octagonal cross-section.

19. A foundation element according to claim 10, wherein each of the at least one hoisting-eye is received within an indention formed at a top surface of the element.

20. A method for manufacturing a foundation element symmetrical about a longitudinal axis thereof, said method comprising the following steps:
(i) obtaining a centrifugal mold formed with a bottom base and side walls extending upwards therefrom;
(ii) introducing at least normal-strength concrete into the mold;
(iii) rotating the mold so as to generate centrifugal force acting on the cement thus forming a peripheral crust;
(iv) decreasing rotation speed of the mold and introducing an additional amount of at least normal-strength concrete into the mold to form a bottom base crust, continuous with the peripheral crust;
(v) introducing into the mold aggregate core material comprising graded material indexed between large size and small sized material;
(vi) rotating the mold at high speed whereby the said crust envelopes the core such that the size of the aggregate material increases from fine to large about a radial section of the element;
(vii) stopping the mold and adding an additional amount of at least normal-strength concrete into the mold to form a top base crust, continuous with the peripheral crust; and
(viii) drying the element.

21. A method according to claim 20, wherein prior to step (vii), at least one eye-hook is introduced into the element.

22. A method according to claim 20, wherein the mold is supported in a vertical position coinciding with the longitudinal axis of the foundation element.

23. A method according to claim 20, wherein the core material comprises waste material.

24. A method according to claim 23, wherein the waste material comprises fly ash.

25. A method according to claim 23, wherein the waste material comprises polymeric material.

26. A method according to claim 23, wherein the waste material comprises radioactive contaminated material.

27. A method according to claim 20, wherein the element has a cylindrical cross-section.

28. A method according to claim 20, wherein the element has a polygonal cross-section having at least three faces.

29. A method according to claim 28, wherein the element has a hexagonal or an octagonal cross-section.

30. A method according to claim 20, wherein an external surface of the core is corrosion resistant.

31. A method according to claim 20, wherein an external surface of the crust is made of high-strength concrete having a compressive strength of at least 50 MPa.

32. A method according to claim 20, wherein step (ii) comprises adding aggregate material comprising graded material indexed between large size and small sized material.

33. A method according to claim 20, wherein steps (ii) to (v) are replaced by a step comprising introducing a mixture comprising cement and a mixture of aggregate material comprising graded material indexed between large size and small sized substance material.

34. A method according to claim 20, wherein after step (v) liquid is withdrawn from the mold and replaced by substitute material.

35. A method according to claim 34, wherein the substitute material is a cement or other reinforcing or bonding material.

36. An apparatus for molding a symmetrical foundation element, said element formed with a crust made of at least normal-strength concrete, said crust enveloping a core made of aggregate material dispersed such that the size of the aggregate material increases from fine to large about a radial section of the element; said apparatus comprising a mold mountable on a rotatable plate member; said mold comprising a base, peripheral side walls extending therefrom and a top cover attachable to the side walls, said top cover comprising an inlet opening.

37. An apparatus according to claim 36, wherein the base of the mold is integral with the plate member.

38. An apparatus according to claim 36, wherein the opening at the top cover is fitted with a funnel and a cylindrical neck portion rotatably supported by a support arm of the apparatus.

39. An apparatus according to claim 36, wherein the top cover is formed with at least one opening to allow an eye-hook to project therefrom.

40. An apparatus according to claim 36, wherein each of the at least one opening is formed at a downward indented portion of the top cover, whereby an eye-hook does not project over a top edge of the side walls, to allow stacking of like foundation elements.

41. An apparatus according to claim 36, wherein the mold is fitted with engagement means for engagement with the rotatable plate member.

42. An apparatus according to claim 36, wherein the mold is fitted with at least one hoisting eye-hook.

43. An apparatus according to claim 36, further comprising a power unit for rotating the rotatable plate member, and control means for controlling speed of revolution.

44. An apparatus according to claim 36, wherein the mold is rotatable about a vertical axis coaxial with a longitudinal axis of the mold.

45. An apparatus according to claim 36, wherein the mold has a cylindrical cross-section.

46. An apparatus according to claim 36, wherein the mold is polygonal cross-section.
